(19) United States
(12) Patent Application Publication
(10) Pub. No.: US 2021/0163689 A1
(43) Pub. Date: Jun. 3, 2021

(54) COMPOUNDS THAT GENERATE NITROGEN GAS AND ENHANCE CHAR FORMATION DURING COMBUSTION, AND INTUMESCENT COATING COMPOSITIONS CONTAINING THEM

(71) Applicant: PPG INDUSTRIES OHIO, INC., CLEVELAND, OH (US)

(72) Inventors: W. DAVID POLK, PITTSBURGH, PA (US); SHANTI SWARUP, ALLISON PARK, PA (US); HONG LI, MARS, PA (US); SUSAN FUNDY DONALDSON, ALLISON PARK, PA (US)

(73) Assignee: PPG INDUSTRIES OHIO, INC., CLEVELAND, OH (US)

(21) Appl. No.: 16/699,797

(22) Filed: Dec. 2, 2019

(51) Int. Cl. C08G 77/16; C09D 183/04; C08G 77/388; C09D 5/18

(52) U.S. Cl. CPC C08G 77/16; C09D 5/185; C08G 77/388; C09D 183/04

(57) ABSTRACT

The present invention is directed to compounds that generate nitrogen gas and enhance char formation upon combustion and to intumescent coating compositions containing them. The compounds of the present invention typically comprise a reaction product of: (i) a nitrogen-containing compound; and (ii) a siloxane-containing compound. The nitrogen-containing compound (i) and the siloxane-containing compound (ii) are covalently bonded directly to each other.

### FIELD OF THE INVENTION

The present invention is directed to compounds that generate nitrogen gas upon combustion and to intumescent coating compositions containing them.

### BACKGROUND OF THE INVENTION

Intumescent coatings are generally applied to the surface of a substrate to change the flaming characteristics of the surface of the substrate, so as to retard the rapid spread of and damage caused by fire. Many materials such as steel quickly lose their strength and fail in a fire. Structural collapse of “high-rise” office blocks, oil and gas facilities or other infrastructure, and process vessel or pipework ruptures caused by fire can be catastrophic in terms of escalation of the incident, damage to property, and even loss of life. In industry, intumescent coatings are applied to, for example, construction components to increase the fire resistance of structures.

Intumescent coatings are used on many structures to delay the destructive effects of a fire. These structures are often made of cold rolled steel, concrete, wood, aluminum, mixed metals, plastic substrates and batteries. The coating slows the rate of heating of the coated substrate by generating an inert expansion gas such as nitrogen. The expansion gas causes the fire protective coating composition to foam and swell; i. e., intumesce, when exposed to high temperatures or flames. As a result of this expansion the char that is formed is a thick, multi-celled material which serves to insulate and protect the underlying substrate. The coating thus increases the time before the structure fails due to the heat of fire. The extra time may aid rescue efforts and makes it more likely that fire fighters will be able to extinguish the fire or at least apply water before the structure fails.

Intumescent coatings generally contain some form of organic resinous binder, for example, a high-temperature tolerant polymer such as an epoxy resin and an appropriate crosslinker. The resinous binder forms a hard coating. If an organic resin is present in the binder, the binder also provides a source of carbon, which is converted to a char when exposed to fire.

The efficacy of the coatings is related to the formation, due to the action of heat, of the thick and porous char foam which operates as a conventional insulator. Thus, it is a very important requirement of an intumescent coating composition to have the ability to uniformly form a carbonaceous char during a fire. The intumescent coatings often contain additives called “spumifics” that generate the expansion gas in a fire, which causes the char to swell into a foam.

Intumescent fire protection coatings are evaluated on protection time, which is influenced by a combination of expansion and char build. Typically, materials that provide good char tend to hinder expansion, and vice versa. It would be desirable to develop a compound that provides both good char and high expansion upon combustion in an effort to increase protection times of intumescent coatings.

### SUMMARY OF THE INVENTION

The present invention is directed to compounds that generate nitrogen gas in a cured intumescent coating upon exposure to fire. The compounds of the present invention typically comprise a reaction product of: (i) a nitrogen-containing compound; and (ii) a siloxane-containing compound. The nitrogen-containing compound (i) and the siloxane-containing compound (ii) are covalently bonded directly to each other.

The present invention is further directed to intumescent coating compositions containing the reaction products.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

The term “polymer” is also meant to include copolymer, oligomer, and prepolymer; i. e., a material that may be chain extended to increase its molecular weight.

Acrylic and methacrylic are designated herein in a summarizing manner as (meth)acrylic. Likewise, allyl and methallyl are designated herein in a summarizing manner as (meth)allyl.

Aliphatic and cycloaliphatic are designated herein in a summarizing manner as (cyclo)aliphatic.

Unless otherwise indicated, molecular weights are reported as number average molecular weights determined by gel permeation chromatography relative to polystyrene standards with the unit of g/mol.

As mentioned above, compounds of the present invention comprise a reaction product of (i) a nitrogen-containing compound; and (ii) a siloxane-containing compound. The nitrogen-containing compound (i) and the siloxane-containing compound (ii) are covalently bonded directly to each other. By “covalently bonded directly to each other” is meant that the bond is formed by reacting functional groups on the nitrogen-containing compound directly with functional groups on the siloxane-containing compound; there is no third reactant forming an intervening linking group or moiety between the residues formed by the reactants (i) and (ii). The nitrogen-containing compound (i) provides a nitrogen gas-forming moiety on the reaction product when the reaction product is exposed to fire and combusted; i. e., upon thermal decomposition. Without intending to be bound to theory, it is believed that the presence of silicon in the char (from the original siloxane-containing compound (ii)) increases the hardness of the char and also increases the efficiency of the char by means of higher residual matter to obtain insulative properties. Additionally, the silicon is distributed more evenly throughout an intumescent coating when used as a component thereof as noted below, compared to conventional intumescent coatings. This allows for more consistent char formation over the surface of the coating during a fire. Each of these advantages provided by the siloxane-containing compound are what is meant by “enhancing char formation”.

Suitable nitrogen-containing compounds (i) that may be used to prepare the reaction products of the present invention include melamines, benzoguanamines, and/or isocyanurates. Typically, the melamines and benzoguanamines are at least partially alkylated to fully alkylated with, for example, methanol or butanol. Commercial examples include CYMEL 303 melamine, and CYMEL 1123 benzoguanamine, both available from Allnex. Suitable isocyanurates include DESMODUR N-3300A, a 100% solids hexamethylene diisocyanate (HDI) trimer (isocyanurate ring); and DESMODUR Z 44700, a 70% solids isophorone diisocyanate (IPDI) trimer (isocyanurate ring), both available from Covestro LLC. VESTANAT T 1890-E, a cycloaliphatic polyisocyanate prepared from isophorone diisocyanate available from Evonik, is also suitable.

The siloxane-containing compounds (ii) used to prepare the reaction products of the present invention are often terminated with at least one active hydrogen group. The siloxane-containing compound (ii) may be mono-, di- or higher (multi-) functional with respect to the active hydrogen group. Examples of suitable active hydrogen groups include most commonly hydroxyl, thiol, carboxyl, and/or amino groups. Often the siloxane-containing compound (ii) comprises a mono- or di-functional hydroxyl terminated polydialkylsiloxane, such as monofunctional hydroxyl terminated polydimethylsiloxane. Examples of commercially available siloxane-containing compounds (ii) include TEGOMER H-Si 2315, a hydroxyl terminated polydimethylsiloxane available from Evonik Corp.; and MCS-C13, a hydroxyl terminated polydimethylsiloxane available from Gelest Inc.

The amount of nitrogen-containing compound (i) (with or without reactive diluents) used to prepare the reaction products of the present invention is usually at least 15, or 16, or 25, or 30, or 33 equivalent percent, and usually at most 50, or 45, or 40 equivalent percent, based on the total equivalents of reactants (i) and (ii) used to prepare the reaction product. The amount of siloxane-containing compound (ii) used to prepare the reaction products of the present invention is usually at least 50, or 53, or 55 equivalent percent, and usually at most 85, or 83, or 80, or 66, or 63 equivalent percent, based on the total equivalents of reactants (i) and (ii) used to prepare the reaction product. Preparation of various exemplary reaction products of the present invention is demonstrated in the Examples A to C below.

The present invention is also drawn to intumescent coating compositions comprising the compound described above. In an intumescent coating composition according to the present invention, the presence of the reaction product described above allows for even distribution throughout the coating of the siloxane moieties that provide char-hardening properties to the coating during combustion. This is because the siloxane-containing compound has been covalently bonded to the nitrogen-containing compound, which yields the expansion gas (nitrogen) upon exposure to fire and during combustion. Without covalent bonding of the siloxane-containing compound to the nitrogen-containing compound, there are often compatibility problems among the components of the coating composition during formulation due to, for example, surface energy differences, resulting in uneven distribution of siloxane functionality throughout the composition. This difference is demonstrated in the Examples below. The coating composition of the present invention produces reinforcing char in a manner that does not impede the expansion of the coating.

The coating compositions are often curable. Curable compositions may comprise a crosslinking agent having reactive functional groups, and one or more film-forming resins having reactive functional groups that are reactive with the reactive functional groups on the crosslinking agent. As used herein, the terms “thermosetting” and “curable” can be used interchangeably and refer to reactive materials that “set” irreversibly upon curing or crosslinking, wherein reactive groups of the components, at least some of which may be polymeric, are joined together by covalent bonds. This property is usually associated with a crosslinking reaction of the composition constituents often induced, for example, by heat, radiation, or the addition of a catalyst. See Hawley, Gessner G., The Condensed Chemical Dictionary, Ninth Edition., page 856; Surface Coatings, vol. 2, Oil and Colour Chemists' Association, Australia, TAFE Educational Books (1974). Once cured or crosslinked, a thermosetting resin will not melt upon the application of heat and is insoluble in solvents. Additionally, as used herein, the terms “film-forming” and “coating” can be used interchangeably.

The crosslinking agent in the intumescent coatings of the present invention may comprise, for example, a polycarboxylic acid, a polyanhydride, a polymercaptan, a polyamine, a polyamide, a polyepoxide, a polyetheramine, and/or a polyol.

An amine crosslinking agent is an organic polyamine compound widely used for epoxy resins, acrylic resins and polyurethane resins. Specific amine crosslinking agents include polyamine, which may contain primary amino groups, secondary amino groups, or both. Secondary amino groups allow for use in a low temperature and/or high humidity environment. Examples thereof include, inter alia, diethylene triamine, triethylene tretraamine, tetraethylene pentamine, isophorone diamine, metaxylylene diamine, metaphenylene diamine, 1,3-bis(aminoethyl)cyclohexane, bis(4-aminocyclohexyl)methane, N-aminoethyl piperazine, 4,4-diaminodiphenyl methane, 4,4′-diamino-3,3-diethyl diphenyl methane and diaminodiphenylsulphone. Commercial grade products of these polyamine crosslinking agents can be used. Various polyetheramines, such as various Jeffamines available from Huntsman Corp., including, but not limited to, Jeffamine 600, Jeffamine 1000, Jeffamine 2005 and Jeffamine 2070 can also be used.

Various polyamides can also be used as a crosslinking agent. Generally, polyamides contain reaction products of dimer fatty acid and a polyethyleneamine, and a small amount of monomer fatty acid. Dimer fatty acid is prepared by the oligomerization of monomer fatty acid. The polyethyleneamine can be any higher polyethyleneamine, such as diethylenetriamine, triethylenetetraamine, tetraethylenepentaamine, etc., wherein the most commonly used is diethylenetriamine.

Other examples of suitable crosslinking agents include the curing agents disclosed in U.S. Pat. No. 5,108,832 at column 5, line 51 to column 6, line 61, incorporated herein by reference as cited.

The crosslinking agent is typically present in the curable composition of the present invention in an amount of 10 to 90 percent by weight, based on the total weight of the crosslinking agent and film-forming resin in the curable composition. For example, the crosslinking agent may be present in the curable composition in an amount of at least 10 percent by weight, often at least 30 percent by weight, or at least 50 percent by weight, or at least 60 percent by weight, based on the total weight of the crosslinking agent and film-forming resin in the curable composition, as demonstrated in the examples below. Moreover, the crosslinking agent may be present in the curable composition in an amount up to 90 percent by weight, or up to 75 percent by weight, often up to 60 percent by weight, based on the total weight of the crosslinking agent and film-forming resin in the curable composition.

The film-forming resin in the intumescent coatings of the present invention may comprise an epoxy resin, an acrylic resin, a polyurethane, a polyurea, a polyvinyl resin, a phenolic resin, a urea-formaldehyde resin, a polyimide, a melamine resin, a polyester resin and/or a cyanate resin. As noted above, the film-forming resin has reactive functional groups that are reactive with the reactive functional groups on the crosslinking agent, and hence are dependent on the identity of the crosslinking agent.

Epoxy resin components comprise at least one polyepoxide. The polyepoxide has at least two 1,2-epoxy groups. Usually the epoxy equivalent weight of the polyepoxide ranges from about 80 to about 2000, typically about 180 to 500. Epoxy compounds can be saturated or unsaturated, cyclic or acyclic, aliphatic, alicyclic, aromatic or heterocyclic. They may comprise substituent(s), such as halogen, hydroxy, and ether groups.

The examples of polyepoxides are those having more than 1 or usually about two 1,2-epoxy equivalents; i. e., polyepoxides having two epoxy groups per molecule on average. The most commonly used polyepoxides are, for example, polyglycidyl ether of polyphenols, such as 2.2-bis(4-hydroxyphenyl)propane (Bisphenol A), resorcinol, hydroquinone, and catechol; or polyglycidyl ether of polyols, such as alicyclic polyols, such as 1,2-cyclohexanediol, 1,4-cyclohexanediol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tert-butylcyclohexyl)propane, 1,3-bis(hydroxymethyl)cyclohexane and 1,2-bis(hydroxymethyl)cyclohexane. The examples of aliphatic polyols include, in particular, trihydroxymethylpentane diol and neopentane diol. A particular suitable polyepoxide has an epoxy equivalent weight of less than 200 g/equivalent. The example includes EPON 828, which is commercially available from Hexion, Inc.

The acrylic resins that may be used in the present invention include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and such as 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate.

Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymers can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl) acrylamides and N-(alkoxymethyl) methacrylamides.

Beta-hydroxy ester functional monomers can be prepared from ethylenically unsaturated, epoxy functional monomers and carboxylic acids having from 5 to 20 carbon atoms, or from ethylenically unsaturated acid functional monomers and epoxy compounds containing at least 5 carbon atoms which are not polymerizable with the ethylenically unsaturated acid functional monomer.

The polymer used in the present invention can also be a polyurethane. Among the polyurethanes which can be used are polymeric polyols which are prepared by reacting polyester polyols or acrylic polyols such as those mentioned above with a polyisocyanate such that the OH/NCO equivalent ratio is greater than 1:1 so that free hydroxyl groups are present in the product.

Additional examples of polyurethane polymers include the polyurethane, polyurea, and poly(urethane-urea) polymers prepared by reacting polyether polyols and/or polyether polyamines with polyisocyanates as known in the art.

Other examples of suitable film-forming resins include the polyepoxides disclosed in U.S. Pat. No. 5,108,832 at column 3, line 40 to column 5, line 50, incorporated herein by reference as cited.

The film-forming resin is typically present in the curable intumescent coating composition of the present invention in an amount of 10 to 90 percent by weight, based on the total weight of the crosslinking agent and film-forming resin in the curable composition. For example, the film-forming resin may be present in the curable composition in an amount of at least 10 percent by weight, often at least 30 percent by weight, or at least 50 percent by weight, or at least 60 percent by weight, based on the total weight of the crosslinking agent and film-forming resin in the curable composition, as demonstrated in the examples below. Moreover, the film-forming resin may be present in the curable composition in an amount up to 90 percent by weight, or up to 75 percent by weight, often up to 60 percent by weight, based on the total weight of the crosslinking agent and film-forming resin in the curable composition.

The reaction product described above is present in the intumescent coating composition in an amount of at least 0.5 percent by weight, such as at least 1 percent by weight or at least 3 percent by weight, and at most 10 percent by weight, such as at most 8 percent by weight, or at most 6 percent by weight, based on the total weight of solids in the intumescent coating composition. The intumescent coating composition may have a solids content of at least 50 percent by weight, or at least 70 percent by weight, or at least 90 percent by weight, such as 100 percent by weight, based on the total weight of the intumescent coating composition.

The intumescent coating composition may contain one or more organic solvents such as aromatic materials including toluene and xylene, high boiling aromatic solvents and aromatic solvent blends derived from petroleum such as those available from ExxonMobil Chemical as AROMATIC 100 or SOLVESSO 100, esters such as ethyl acetate, butyl acetate and amyl acetate, ethers such as dialkyl ethers of ethylene and propylene glycol, and ketones such as acetone, methyl ethyl ketone and methyl amyl ketone.

The curable intumescent coating compositions may be prepared as one-package systems as known in the art, depending on the reactive functional groups on the crosslinking agent and film-forming resin, through any method known in the art. The above components can be mixed at desired ratios. In one example, the above components are sequentially added into a container, and then stirred until homogeneous. There is no particular limitation on the addition order for the components.

The curable intumescent coating compositions can alternatively be prepared as a multi-package, such as a two-package (“2K”), composition, often curable at ambient temperature. The terms “multi-package systems” and “multi-package compositions” mean compositions in which various components are maintained separately until just prior to use, such as by application to a substrate as a coating. By “ambient” is meant the condition of surroundings without adjustment of the temperature, humidity or pressure. Ambient temperature usually ranges from 40 to 95° F. (about 4 to 35° C.), often 60 to 95° F. (about 15 to 35° C.), such as a typical room temperature, 72° F. (22.2° C.). Multi-package curable compositions are typically prepared by combining the ingredients immediately before use.

When preparing the curable composition according to the present invention as a multi-package composition, the intumescent coating composition may be a two-package composition, and the reaction product is present with the crosslinking agent in a first package and/or with the film-forming resin in a second package. Alternatively, the intumescent coating composition may be a three-package composition, with the reaction product in a third package.

When the reaction product is added to the first package containing the crosslinking agent, the first package demonstrates a viscosity of 195 Pa-s to 206 Pa-s at 25° C. according to Brookfield viscometer measurements (using spindle 07, at 12 rpm). This viscosity is significantly (more than 20%) lower than that of commercially available crosslinking packages used in intumescent coatings, and demonstrates an advantage of the present invention.

Optional ingredients such as catalysts, dyes, pigments, tints, plasticizers, anti-oxidants, thixotropic agents, reactive diluents, hindered amine light stabilizers, UV light absorbers and stabilizers may be formulated into the curable compositions of the present invention. These ingredients may be present (on an individual basis) in amounts up to 30 percent by weight, often from 0.1 to 5 percent by weight, based on the total weight of the crosslinking agent and film-forming resin in the curable composition.

Typical catalysts include aliphatic amines, such as triethanolamine, triethylenediamine, etc.; anhydride catalysts, such as BDMA, DBU, etc.; polyetheramine catalysts; tin catalysts, such as dibutyltin dilaurate, stannous octoate, etc. In one example of the present invention, the catalyst is ANCAMINE K54, which is commercially available from Air Products.

Although not an essential ingredient in intumescent reactions, inorganic “nucleating” agents are often included since they provide sites for the intumescent char to form, and improve the thermal resistance properties and stability of the intumescent char during a fire.

Examples of nucleating agents include titanium dioxide, zinc oxide, aluminum oxide, silica, silicates, heavy metal oxides such as cerium oxide, lanthanum oxide and zirconium oxide, calcium carbonite, carbon black, talcum, wollastonite, micaceous iron oxide, china clay, mica and bentonite clay. A nucleating agent such as titanium dioxide may also provide opacity to the coating. The nucleating agent is typically included in the intumescent coating at from 3 to 20 percent by weight, such as 3 to 15 percent by weight, or even 8 to 12 percent by weight, based on the total weight of the intumescent coating composition.

Further additives may be optionally included as part of the intumescent ingredients to aid char formation and to strengthen the char and prevent char degradation. Such additives include solids such as zinc borate, zinc stannate, zinc hydroxystannate, glass flake, glass spheres, polymeric spheres, fibers (ceramic, mineral, glass/silica based), aluminum hydroxide, antimony oxide, boron phosphate, fumed silica. Particularly suitable fibers include engineered mineral fibers that are 100 to 500 microns in length. Such additives may be included in the intumescent coating at from 1 to 5 percent by weight, based on the total weight of the intumescent coating composition.

Further, rheology modifiers, such as a thixotrope may be included in the intumescent coating composition. Suitable thixotropic additives include organically modified inorganic clays such as bentonite clays, hectorite clays or attapulgite clays, organic wax thixotropes based on castor oil and castor oil derivatives, and fumed silica.

To improve or facilitate dispersion of the intumescent ingredient (the reaction product) and also to reduce the overall viscosity of the intumescent coating, it may be desired to incorporate wetting/dispersion additives. Such additives are usually liquid in form and can be supplied with or without a solvent.

The intumescent compositions of the present invention may further comprise a halogenated polymeric resin as a flame retardant and/or char expansion agent. A particularly suitable flame retardant includes chlorinated paraffin, which may be included in the composition at from 0 to 15 percent by weight, such as 2 to 10 percent by weight, based on the total weight of the intumescent coating composition.

Furthermore, the pigment volume concentration (PVC) may be at least 30 percent, or 50 percent, or 55 percent, up to 70 percent, or 75 percent, or 80 percent, “PVC”, as used herein, is equal to the volume of pigment compared to the total volume of all solids in the coating composition.

Preparation of exemplary intumescent coating compositions in accordance with the present invention is demonstrated in the Examples below.

The present invention is further drawn to coated articles comprising substrates at least partially coated with an intumescent coating composition as described herein. The intumescent coating compositions of the present invention may be applied over any of a variety of substrates including rigid metal substrates, such as ferrous metals, aluminum, aluminum alloys, copper, and other metals or alloys. Exemplary ferrous metal substrates useful in the practice of the present invention include iron, steel, and alloys thereof. The substrates may be bare, pretreated, or coated with a primer and/or sealer. Steel sections requiring fire protection are normally blast cleaned prior to the application of an intumescent coating to remove millscale and other deposits that may lead to premature failure of the intumescent coating, either on prolonged atmospheric exposure or during a fire situation. In order to prevent deterioration of the blast cleaned surface, particularly where there is a delay in applying the intumescent coating, it is normal practice to apply a primer coating. This is often the case when the intumescent coating is applied on site. Examples of suitable primers are coatings based on epoxy, modified epoxy (such as modified with polyvinyl butyral), polyurethane, acrylic, vinyl and chlorinated rubber. The thickness of the primer may be in the range from 15 microns to 250 microns, such as in the range from 25 microns to 100 microns.

The intumescent coating compositions are most often applied to the substrate by spraying. The usual spray techniques and equipment for air spraying, airless spraying, and electrostatic spraying employing manual and/or automatic methods can be used.

Coating layers typically have a film thickness of 0.1 to 20 mm, such as 0.5 to 20 mm, 0.5 to 18 mm, or 0.8 to 16 mm. Alternatively, the coating composition of the present invention can have a coating thickness of 0.1, 0.2, 0.3, 0.4, 0.5, 0.6, 0.7, 0.8 or 0.9 mm to 10, 11, 12, 13, 14, 15, 16, 17, 18, 19 or 20 mm. Alternatively, the coating composition of the present invention can have a coating thickness of 1, 2, 3, 4, 5 or 6 mm to 10, 11, 12, 13, 14, 15, 16, 17, 18, 19 or 20 mm. The endpoints of the above ranges can be arbitrarily combined to define the coating thicknesses of the intumescent coating compositions of the present invention on a coated substrate to which they were applied.

A topcoat may be applied to the intumescent coatings of the present invention, particularly to provide color to exposed steelwork. A topcoat may enhance the durability of the intumescent coating compositions. A clear sealer may also be suitable. Examples of suitable topcoats are coatings based on epoxy, polyurethane, alkyd, acrylic, vinyl or chlorinated rubber. The thickness of the topcoat can vary from 15 microns to 250 microns, such as from 25 microns to 75 microns, as too high a thickness of topcoat may inhibit the intumescent reactions.

A coated article of the present invention may comprise, for example, structures such as a building or bridge; commercial vehicle, industrial protective structure such as an electrical box enclosure, transformer housing, or motor control enclosure; railcar, railcar container, water tower, power line tower, tunnel, oil or gas industry component such as drilling oil rigs, platforms, pipes, tanks, vessels, and their supports, marine component such as a ship's hull, automotive body part, aerospace component, bridge support structure, pipeline, storage tank, or wind turbine component.

Each of the characteristics and examples described above, and combinations thereof, may be said to be encompassed by the present invention. In view of the foregoing the present invention relates e.g. to the following nonlimiting aspects:

1. A compound comprising a reaction product of (i) a nitrogen-containing compound; and (ii) a siloxane-containing compound; wherein the nitrogen-containing compound (i) and the siloxane-containing compound (ii) are covalently bonded directly to each other, and wherein the reaction product generates nitrogen gas upon combustion.

2. The compound of aspect 1, wherein the nitrogen-containing compound (i) comprises a melamine, a benzoguanamine, and/or an isocyanurate.

3. The compound of aspect 1 or 2, wherein the nitrogen-containing compound (i) comprises an at least partially alkylated melamine and/or an at least partially alkylated benzoguanamine.

4. The compound of any of aspects 1 to 3 wherein the siloxane-containing compound (ii) is terminated with at least one active hydrogen group.

5. The compound of aspect 4, wherein the siloxane-containing compound (ii) is multi-, di- or monofunctional with respect to the active hydrogen group.

6. The compound of aspect 4, wherein the active hydrogen group comprises a hydroxyl, thiol, carboxyl, or amino group.

7. The compound of any of aspects 1 to 6, wherein the siloxane-containing compound (ii) comprises monofunctional hydroxyl terminated polydimethylsiloxane.

8. An intumescent coating composition comprising the compound of any of aspects 1 to 7.

9. The intumescent coating composition of aspect 8, further comprising a crosslinking agent having reactive functional groups and one or more film-forming resins having reactive functional groups that are reactive with the reactive functional groups on the crosslinking agent.

10. The intumescent coating composition of aspect 9, wherein the intumescent coating composition is a two-package composition, and the compound is present with the crosslinking agent in a first package and/or with the film-forming resin in a second package.

11. The intumescent coating composition of any of aspects 9 to 10, wherein the crosslinking agent comprises: a polycarboxylic acid, a polyanhydride, a polymercaptan, a polyamine, a polyamide, a polyepoxide, a polyetheramine, and/or a polyol, and the film-forming resin comprises: an epoxy resin, an acrylic resin, a polyurethane, a polyurea, a polyvinyl resin, a phenolic resin, a urea-formaldehyde resin, a polyimide, a melamine resin, a polyester resin and/or a cyanate resin.

12. The intumescent coating composition of any of aspects 8 to 11, wherein the compound is present in the intumescent coating composition in an amount of 0.5 to 10 percent by weight, based on the total weight of solids in the intumescent coating composition.

13. The intumescent coating composition of any of aspects 8 to 12, wherein the intumescent coating composition has a solids content of at least 90 percent by weight, based on the total weight of the intumescent coating composition.

14. A coated article comprising a substrate at least partially coated with the intumescent coating composition of any of aspects 8 to 13.

15. The coated article of aspect 14, wherein the coated article comprises a building; bridge; commercial vehicle; electrical box enclosure; transformer housing; motor control enclosure; railcar; railcar container; water tower; power line tower; tunnel; drilling oil rig; drilling oil platform; drilling oil pipe; drilling oil tank; drilling oil vessel; marine component; automotive body part; aerospace component; bridge support structure; pipeline; storage tank; or wind turbine component.

16. Use of the compound as defined in any of aspects 1-7 to generate nitrogen gas and/or enhance char formation in a cured coating deposited from the intumescent coating composition as defined in any of aspects 8-13 upon exposure of the cured coating to fire.

The present invention will further be described by reference to the following examples. The examples are merely illustrative of the invention and are not intended to be limiting. Unless otherwise indicated, all parts are by weight.

Examples A, B, and C demonstrate the preparation of various reaction products of (i) a nitrogen-containing compound; and (ii) a siloxane-containing compound in accordance with the present invention.

### Example A

A covalently bonded reaction product was prepared by adding 105.42 grams of a hydroxyl terminated polydimethylsiloxane (TEGOMER H-Si 2315, available from Evonik Corp.), 4.0 grams of n-amyl alcohol (Dow Chemical), 8.8 grams of alkylated melamine (CYMEL 303, available from Allnex), 32.00 grams of light aromatic solvent Naphtha (SOLVESSO 100, available from ExxonMobil Chemical), and 0.03 grams of dodecylbenzylsulphonic acid solution (DDBSA or CYCAT 600, available from Allnex) to a suitable reaction vessel equipped with a stirrer, temperature probe, and Dean-Stark trap with a condenser, under a nitrogen atmosphere. The contents of the reactor were gradually heated to 90° C. and then held until either 1.0 grams of methanol had been collected or 3 hours at 90° C. had elapsed. The contents of the reactor were cooled to room temperature and poured. The final resin solution had a measured percent solids (110° C./1 hour) of 76.26%. and a Mw of 5767 via THF GPC.

### Example B

A covalently bonded reaction product was prepared by adding 242.25 grams of a hydroxyl terminated polydimethylsiloxane (MCS-C13, available from Gelest Inc.), 52.25 grams of alkylated melamine (CYMEL 303, available from Allnex), and 0.19 grams of dodecylbenzylsulphonic acid solution (DDBSA or CYCAT 600, available from Allnex) to a suitable reaction vessel equipped with a stirrer, temperature probe, and Dean-Stark trap with a condenser, under a nitrogen atmosphere. The contents of the reactor were gradually heated to 90° C. for 1 hour then held at 105° C. until either 13.0 grams of methanol had been collected or 3 hours at 105° C. had elapsed. The contents of the reactor were cooled to room temperature and poured. The final resin solution had a measured percent solids (110° C./1 hour) of 97.42%. and a Mw of 3387 via THF GPC.

### Example C

A covalently bonded reaction product was prepared by adding 80.00 grams of a hydroxyl terminated polydimethylsiloxane (TEGOMER H-Si 2315, available from Evonik Corp.), 21.26 grams of alkylated benzoguanamine (CYMEL 1123, available from Allnex), 20.00 grams of cyclohexanol (NAXOL Cyclohexanol, available from AdvanSix) and 0.05 grams of dodecylbenzylsulphonic acid solution (DDBSA or CYCAT 600, available from Allnex) to a suitable reaction vessel equipped with a stirrer, temperature probe, and Dean-Stark trap with a condenser, under a nitrogen atmosphere. The contents of the reactor were gradually heated to 90° C. for 1 hour then held at 110° C. until either 3.0 grams of distillate had been collected or 3 hours at 110° C. had elapsed. The contents of the reactor were cooled to room temperature and poured. The final resin solution had a measured percent solids (110° C./1 hour) of 99.90%. and a Mw of 20982 via THF GPC.

### FORMULATION EXAMPLES

Example 1 is a comparative example. It is a 2-component intumescent coating prepared as described in WO2019/0202506 A1 (Comparative Example 1 in Table 2)

Example 2 is an example of an intumescent coating according to the present invention, prepared as Example 1 above with the additional components of melamine-siloxane reaction products of this invention as previously described.

Example 3 is prepared as Example 1 with the additional components of alkylated melamine only. (liquid form of melamine derivative used to make melamine-siloxane molecule in this invention). It serves as a negative control.

Example 4 is prepared as Example 1 with the additional components of hydroxyl terminated siloxane. (siloxane used to make melamine-siloxane molecule in this invention). It serves as a negative control.

Example 5 is prepared as Example 1 with the additional components of fully blended, but not reacted, compounds used in making the melamine-siloxane reaction product of Example A above, including liquid alkylated melamine, hydroxyl terminated siloxane, AROMATIC 100, and amyl alcohol. It serves as a negative control.

All additional components in Example 2-5 are added to the final coating composition at the same level of 1.28% in weight.

| | Exam- | Exam- | Exam- | Exam- | Exam- |
|---|---|---|---|---|---|
| | ple 1 | ple 2 | ple 3 | ple 4 | ple 5 |
| 2-component intumescent | 100 | 98.72 | 98.72 | 98.72 | 98.72 |
| coating prepared | | | | | |
| as described in | | | | | |
| WO2019/0202506 A1 | | | | | |
| Reaction product | — | 1.28 | — | — | — |
| of Example A | | | | | |
| Alkylated melamine | — | — | 1.28 | — | 0.08 |
| (CYMEL 303) | | | | | |
| Hydroxyl | — | — | — | 1.28 | 0.9 |
| functional siloxane | | | | | |
| (TEGOMER H—Si | | | | | |
| 2315) | | | | | |
| AROMATIC 100 | — | — | — | — | 0.270 |
| Amyl alcohol | — | — | — | — | 0.0303 |

### Fire Testing:

The intumescent coating compositions from Example 1 to 5 were trowel-applied to steel panel structures. The steel panel structure has a dimension of depth 3/16″, length 7″ and width 3″. After application, the coated structures were left for drying for 7 days, and final film thickness of coatings were measured before subjecting fire tests. All dry film thickness were maintained at 8.5 mm. Fire tests using UL 1709 fire curve are carried out in a sealed furnace.

### Char Behavior Testing:

Char performance is characterized by two parameters: expansion ratio and hardness. Expansion ratio is defined in the way that thickness of the char is divided by dry coating film thickness. Char hardness is measured by a finger-compressing test protocol where each is ranked from 1 (softest) to 10 (hardest) (Refer to US2018/0002536 A1 Table 5). In this case, the char hardness rating of comparative example is set as 5.

TABLE 1
Example composition and fire test results

| | | Example 2 | Example 3 | Example 4 | Example 5 |
|---|---|---|---|---|---|
| | | melamine-siloxane | Melamine only | Siloxane only | full blends |
| | Example 1 | molecule | (negative | (negative | (negative |
| | control | (present invention) | control) | control) | control) |
| Char | 3.0 | 5.2 | 4.2 | 4.3 | 4 |
| expansion | | | | | |
| Char | 5 | 7 | 4 | 6 | 6 |
| hardness | | | | | |

### Result Discussion:

Example 1 has char expansion and hardness of 3.0 and 5, respectively. After adding the melamine-siloxane reaction product as an additive, described in this invention, to Example 1, both char expansion and hardness were increased at the same time (Example 2). Negative control experiments were conducted via adding melamine only (Example 3), siloxane only (Example 4), or physical blends (Example 5), respectively, to Example 1, and none of them achieved the same level of char expansion and hardness as Example 2, the present invention. This demonstrates that a reaction product of (i) a nitrogen-containing compound; and (ii) a siloxane-containing compound; wherein the nitrogen-containing compound (i) and the siloxane-containing compound (ii) are covalently bonded directly to each other, enhances both char expansion and hardness at the same time.

Whereas particular examples of this invention have been described above for purposes of illustration, it will be evident to those skilled in the art that numerous variations of the details of the present invention may be made without departing from the invention as defined in the appended claims.

What is claimed is:

1. A compound comprising a reaction product of (i) a nitrogen-containing compound comprising a melamine, a benzoguanamine, and/or an isocyanurate; and (ii) a siloxane-containing compound; wherein the nitrogen-containing compound (i) and the siloxane-containing compound (ii) are covalently bonded directly to each other, and wherein the reaction product generates nitrogen gas upon combustion.

2. The compound of claim 1, wherein the nitrogen-containing compound (i) comprises an at least partially alkylated melamine and/or an at least partially alkylated benzoguanamine.

3. The compound of claim 1, wherein the siloxane-containing compound (ii) is terminated with at least one active hydrogen group.

4. The compound of claim 3, wherein the siloxane-containing compound (ii) is multi-, di- or monofunctional with respect to the active hydrogen group.

5. The compound of claim 3, wherein the active hydrogen group comprises a hydroxyl, thiol, carboxyl, or amino group.

6. The compound of claim 3, wherein the siloxane-containing compound (ii) comprises monofunctional hydroxyl terminated polydimethylsiloxane.

7. An intumescent coating composition comprising the compound of claim 1.

8. The intumescent coating composition of claim 7, further comprising a crosslinking agent having reactive functional groups and one or more film-forming resins having reactive functional groups that are reactive with the reactive functional groups on the crosslinking agent.

9. The intumescent coating composition of claim 8, wherein the intumescent coating composition is a two-package composition, and the compound is present with the crosslinking agent in a first package and/or with the film-forming resin in a second package.

10. The intumescent coating composition of claim 8, wherein the crosslinking agent comprises: a polycarboxylic acid, a polyanhydride, a polymercaptan, a polyamine, a polyamide, a polyepoxide, a polyetheramine, and/or a polyol, and the film-forming resin comprises: an epoxy resin, an acrylic resin, a polyurethane, a polyurea, a polyvinyl resin, a phenolic resin, a urea-formaldehyde resin, a polyimide, a melamine resin, a polyester resin and/or a cyanate resin.

11. The intumescent coating composition of claim 8, wherein after application of the intumescent coating composition to a substrate and after curing of the intumescent coating composition to form a cured coating, the compound generates nitrogen gas upon combustion.

12. The intumescent coating composition of claim 7, wherein the compound is present in the intumescent coating composition in an amount of 0.5 to 10 percent by weight, based on the total weight of solids in the intumescent coating composition.

13. The intumescent coating composition of claim 8, wherein the intumescent coating composition has a solids content of at least 90 percent by weight, based on the total weight of the intumescent coating composition.

14. A coated article comprising a substrate at least partially coated with the intumescent coating composition of claim 7.

15. The coated article of claim 14, wherein the coated article comprises a building; bridge; commercial vehicle; electrical box enclosure; transformer housing; motor control enclosure; railcar; railcar container; water tower; power line tower; tunnel; drilling oil rig; drilling oil platform; drilling oil pipe; drilling oil tank; drilling oil vessel; marine component; automotive body part; aerospace component; bridge support structure; pipeline; storage tank; or wind turbine component.
